(19) United States
(12) Patent Application Publication
(10) Pub. No.: US 2009/0053457 A1
(43) Pub. Date: Feb. 26, 2009

(54) INSERT MOLDED ARTICLE

(75) Inventors: ZHI-GANG ZOU, Shenzhen (CN); GUO-LIANG HU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/959,261

(22) Filed: Dec. 18, 2007

(30) Foreign Application Priority Data
Aug. 24, 2007 (CN) 200710076572.8

(51) Int. Cl. B32B 3/02

(52) U.S. Cl. 428/67

(57) ABSTRACT

An insert molded article (10) includes an insert component (12) and a molded component (14). The insert component includes a main body (121) and at least one protrusion (122) protruding outwardly from the main body. The at least one protrusion have a free end larger than an opposed other end thereof abutting against the main body in sectional area. The molded component has an inner wall (144) molded with the insert component. The inner wall has at least one latching notch (145) formed therein. The at least one protrusion of the insert component is moldingly embedded in the at least one latching notch in a snap fit engagement.

### CROSS-REFERENCE TO RELATED APPLICATIONS

This application claims all benefits accruing under 35 U.S.C. §119 from China Patent Application No. 200710076572.8, filed on Aug. 24, 2007 in the China Intellectual Property Office, the disclosure of which is incorporated herein by reference.

### BACKGROUND OF THE INVENTION

1. Field of the Invention

The present invention generally relates to insert molded articles, particularly to an insert molded article made by injection molding.

2. Description of Related Art

In the formation of molded articles, it is often desired to integrate various preformed items with the molded article during the molding process. A typical method for incorporating preformed items with a molded article is insert molding. Insert molding involves a first step of placing the preformed item into a desired location within a mold, and a second step of adding a molten moldable material, such as polymer either, into the mold in such a manner that the polymer either contacts or surrounds at least part of the preformed item. As the moldable material is cured by cooling, the preformed item is incorporated into the molded article.

In the typical insert molding method, the mold is desirably provided with a specially tooled holding structure for holding the preformed item in place during the molding process. As the moldable material is injected into the mold, the preformed item disposed in the mold is exposed to high pressure and heat generated from the moldable material, for the purpose of ensuring the accuracy of the contour of the molded article while complementing the volume contraction of the molten resin accompanied with the solidification thereof. However, the high pressure and heat generated from the moldable material may be with the result that the preformed item adheres to the holding structure of the mold. When the molded article is ejected to separate from the mold, the preformed item may be undesirably retained in the mold. As a result of that, the preformed item is prone to detached from the molded article.

Therefore, an improved insert molded article is desired in order to overcome the above-described shortcomings.

### SUMMARY OF THE INVENTION

In one embodiment thereof, an insert molded article is provided. The insert molded article includes an insert component and a molded component. The insert component includes a main body and at least one protrusion protruding outwardly from the main body. The at least one protrusion have a free end larger than an opposed other end thereof abutting against the main body in sectional area. The molded component has an inner wall molded with the insert component. The inner wall has at least one latching notch formed therein. The at least one protrusion of the insert component is moldingly embedded in the at least one latching notch in a snap fit engagement.

Other advantages and novel features will become more apparent from the following detailed description of preferred embodiments when taken in conjunction with the accompanying drawings.

### BRIEF DESCRIPTION OF THE DRAWINGS

Many aspects of the insert molded article can be better understood with reference to the following drawing. The components in the drawing are not necessarily drawn to scale, the emphasis instead being placed upon clearly illustrating the principles of the insert molded article. Moreover, in the drawing like reference numerals designate corresponding parts throughout the several views.

FIG. 1 is an exploded view of a first embodiment of an insert molded article;

FIG. 2 is a perspective view of the insert molded article, as shown in FIG. 1;

FIG. 3 is an exploded view of a second embodiment of an insert molded article;

FIG. 4 is a perspective view of an insert component of the insert molded article, as shown in FIG. 3;

FIG. 5 is a perspective view of the insert molded article, as shown in FIG. 3;

FIG. 6 is an exploded view of a third embodiment of an insert molded article;

FIG. 7 is a schematic view of a first embodiment of protrusions of an insert component of the insert molded article as shown in FIG. 6;

FIG. 8 is a schematic view of a second embodiment of protrusions of an insert component of the insert molded article as shown in FIG. 6; and

FIG. 9 is a schematic view of a third embodiment of protrusions of an insert component of the insert molded article as shown in FIG. 6.

### DETAILED DESCRIPTION OF THE INVENTION

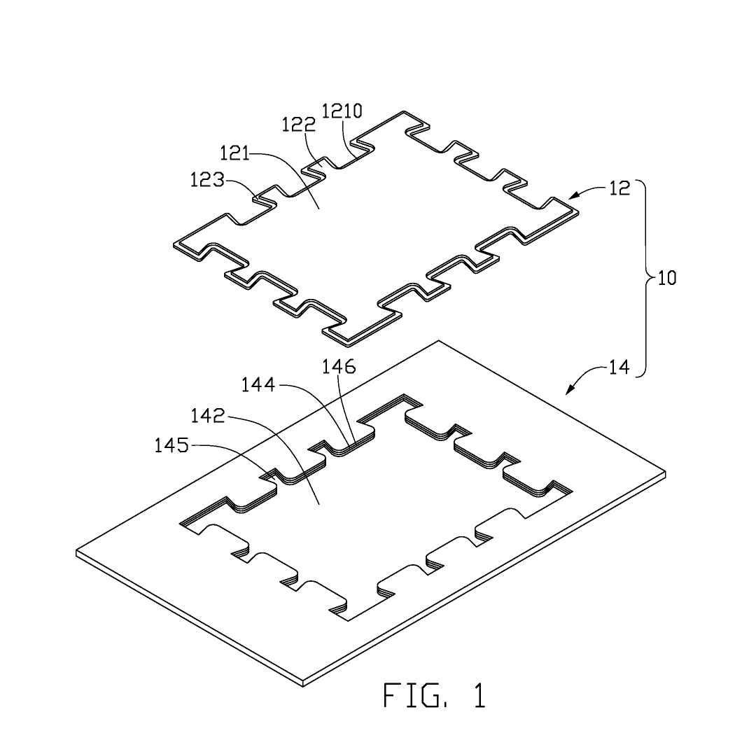

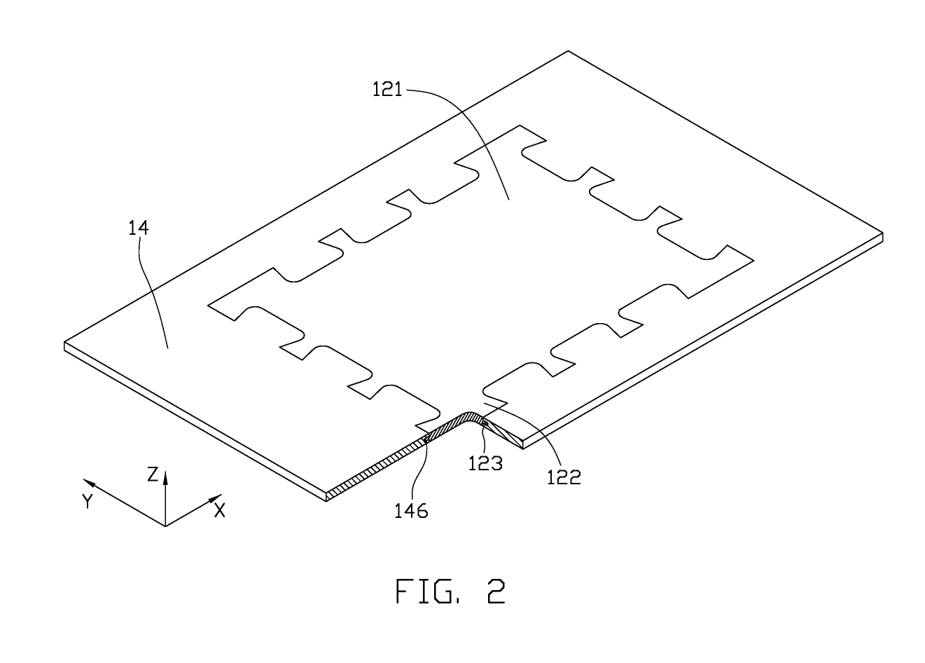

Referring to FIG. 1 and FIG. 2, in a first embodiment, a first insert molded article 10 includes a first insert component 12 and a first molded component 14 molded with the first insert component 12.

The first insert component 12 is jigsaw-shaped and includes a first main body 121, a plurality of first protrusions 122 protruding outwardly around a peripheral edge 1210 of the first main body 121, and a first embedded brim 123. The first main body 121 may be plate-shaped. Each of the first protrusions 122 may be a trapezoid-shaped configuration, which has a free end larger than an opposed other end thereof abutting against the first main body 121 in sectional area. The first protrusions 122 are evenly spaced apart from each other. The first embedded brim 123 protrudes outwardly around both the peripheral edge 1210 of the first main body 121 and the first protrusions 122. The insert component 12 may be a metal piece or a glass piece.

The first molded component 14 has a first through opening 142 defined therein and formed by a first inner wall 144. The first molded component 14 further has a plurality of first latching notches 145 defined therein and communicating with the first through opening 142. The first through opening 142 is configured to receive the first main body 121. Each of the first latching notches 145 is configured for receiving one of the first protrusions 122. The first inner wall 144 has a first latching slot 146 formed therein and around the first through opening 142 and the first latching notches 145. The first molded component 14 may be made of a plastic chosen from a group consisting of polyvinyl chloride, polyethylene terephthalate, acrylonitrile-butadiene-styrene, polycarbonate, polyimide, liquid crystal polymer, polyetherimide, polyphenylene sulfide, polysulfone, polystyrene, glycol-modified polyester, polypropylene, and any desired combination thereof.

The first molded component 14 is molded with the first insert component 12, with the first inner wall 144 being attached to the peripheral edge 1210 of the first main body 121. The first main body 121 and the first protrusions 122 of the first insert component 12 are respectively moldingly received into the first through opening 142 and the first latching notches 145 in a snap fit type engagement. The first embedded brim 123 is moldingly embedded into the first latching slot 146.

In order to simplify the description of the first embodiment of the present invention, the following description is made with reference to Cartesian axes, as shown in FIG. 2. The first molded component 14 can be formed onto the first insert molded article 12 via an injection molding process in a mold (not shown). After the first molded component 14 being molded onto the insert component 12, the first insert molded article 10 with the first molded component 14 is ejected from the mold (not shown). During the ejecting process, the snap fit type engagement of the first insert component 12 into the first molded component 14 can prevent the first insert component 12 detaching form the first molded component 14 in the X axis, the Y axis, and/or, the Z axis. Thus, no movement of the insert component 12 relative to the first molded component 14 in the X axis, the Y axis, and/or, the Z axis may occur.

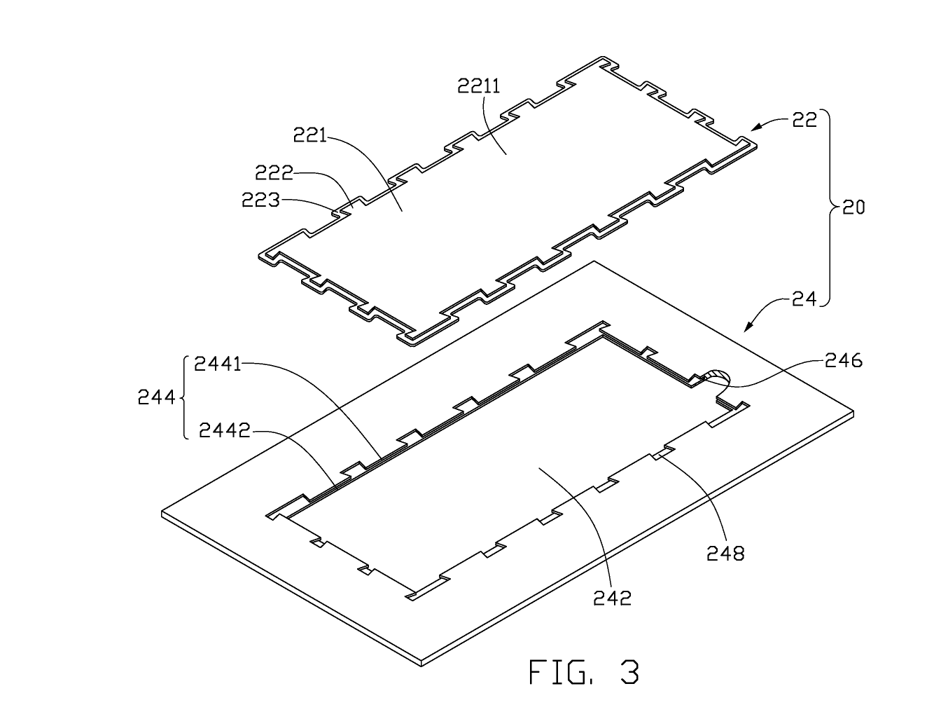

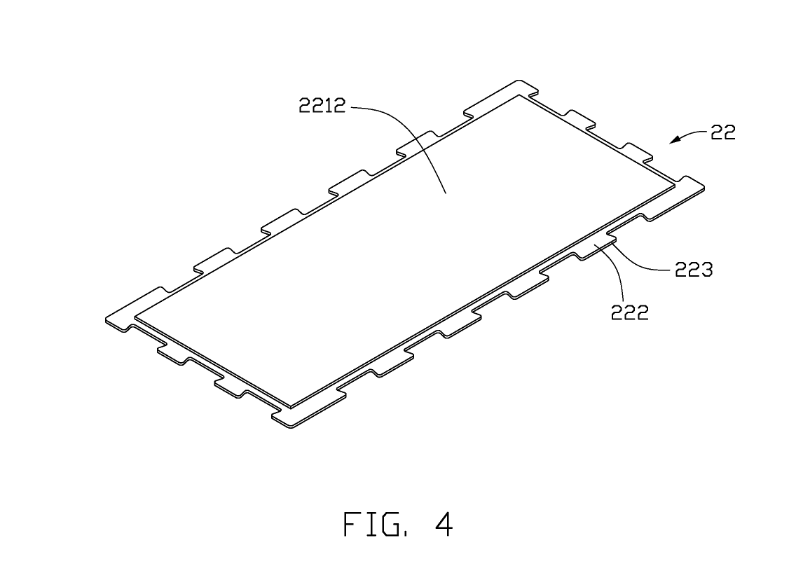

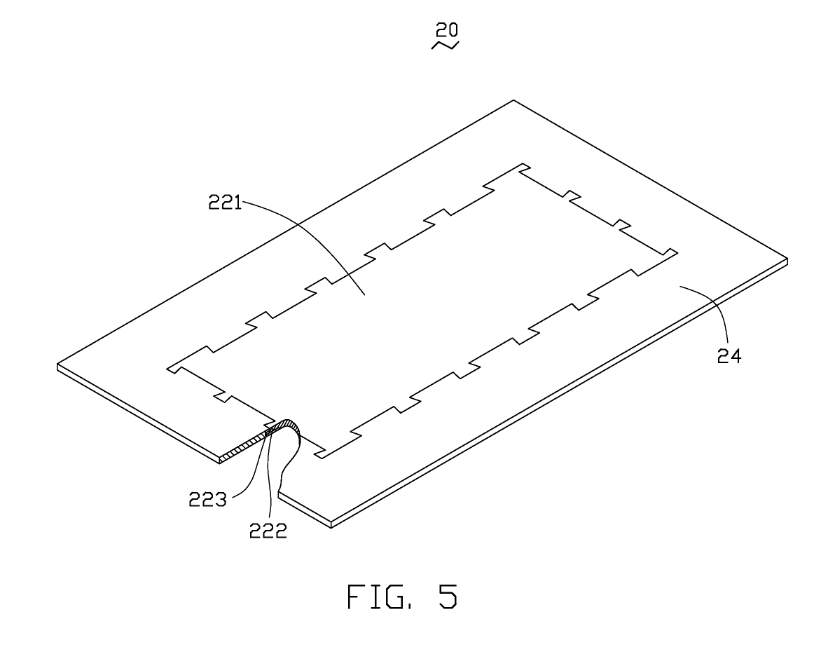

Referring to FIG. 3 to FIG. 5, in a second embodiment, a second insert molded article 20 includes a second insert component 22 and a second molded component 24 molded with the second insert component 22.

The second insert component 22 includes a second main body 221, a plurality of second protrusions 222 protruding outwardly the second main body 221, and a second embedded brim 223. The second main body 221 has a first surface 2211 and a second surface 2212 opposed to the first surface 2211. Each of the second protrusions 222 may be a trapezoid-shaped configuration, which has a free end larger than an opposed other end thereof abutting against the second main body 221 in sectional area. The second protrusions 222 are evenly spaced apart from each other. The second embedded brim 223 protrudes outwardly around both the peripheral edge 1210 of the second main body 221 and the second protrusions 222. The second protrusions 222 are even with (i.e., being in the same plane) the first surface 2211 of the second main body 221. The thickness of each of the second protrusions 222 is less than that of the second main body 221.

The second molded component 24 has a second through opening 242 defined therein formed by a second inner wall 244. The second inner wall 244 has a second latching slot 246 formed therein and around the second through opening 242. The second latching slot 246 divides the second inner wall 244 into an upper wall portion 2441 and a lower wall portion 2442. The upper wall portion 2441 has a plurality of second latching notches 248 formed therein and communicating with the second through opening 242. The second through opening 242 is configured to receive the second main body 221. Each of the second latching notches 248 is configured to receive one of the second protrusions 222. The second latching slot 246 is configured for receiving the second embedded brim 223.

The second molded component 24 is molded with the second insert component 22, with the second inner wall 244 being attached to the second insert component 22. The second main body 221 and the second protrusions 222 of the second insert component 22 are respectively moldingly received into the second through opening 242 and the second latching notches 246. The second embedded brim 223 is moldingly embedded into the second latching slot 246 in a snap fit type engagement. Thus, the second insert component 22 is mechanically locked into the second molded component 24, and no movement of the second insert component 22 relative to the second molded component 24 may occur.

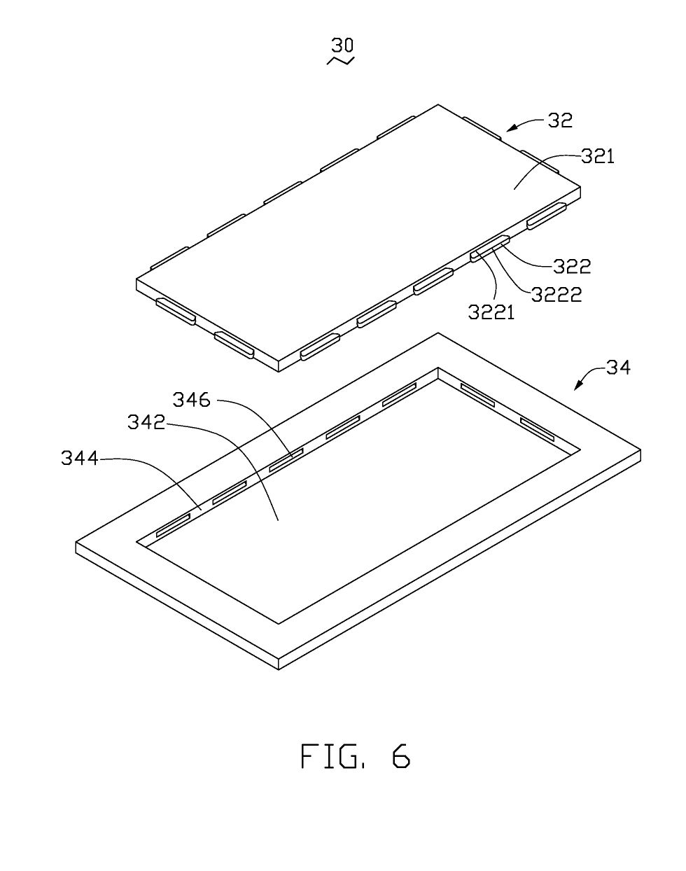

Referring to FIG. 6, in a third embodiment, a third molded article 30 includes a third insert component 32 and a third molded component 34 molded with the third insert component 32.

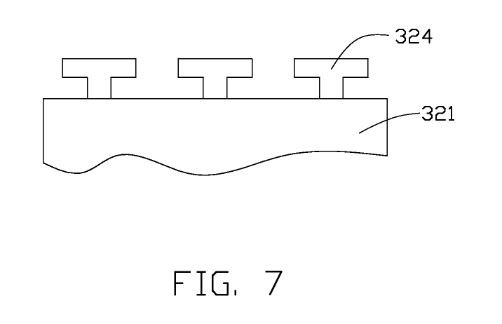

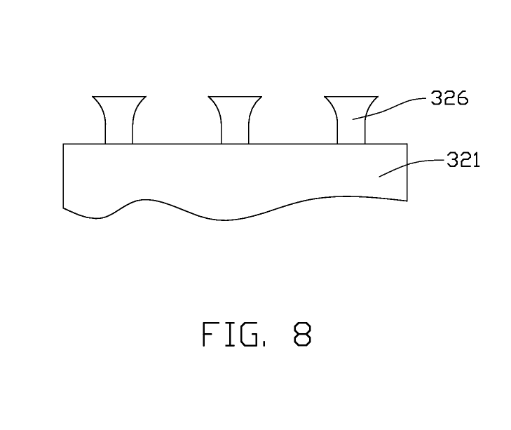

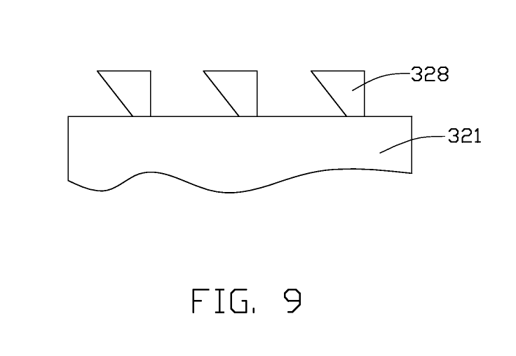

The third insert component 32 includes a third main body 321 and a plurality of third protrusions 322 protruding outwardly around the third main body 321. Each of third protrusions 322 has a free end and abutting against the third main body 321 and a third free end 3222 opposed to the third fixed end 3221. The third free end 3222 has a sectional area larger than that of the third fixed end 3221. The third protrusions 322 are spaced apart from each other. It should be understood that, referring to FIG. 7, FIG. 8, and FIG. 9, each of the third protrusions 322 may instead be a T-shaped arm 324, a horn-shaped protrusion 326, or trapezium-shaped protrusion 328.

The third molded component 34 has a third through opening 342 formed therein. The third through opening 342 is configured to receive the third main body 321 of the insert component 32. The third molded component 34 has a third inner wall 344 defining the third through opening 342. The third inner wall 344 has a plurality of third latching notches 346 formed therein and arranged around the third through opening 342. The third through opening 342 is configured for receiving the third main body 321. Each of the third latching notches 346 is configured to receive one of the third protrusions 322.

The third molded component 34 is molded onto the third insert component 32, with third inner wall 344 being attached to the third insert component 32. The third main body 321 and the third protrusions 322 of the third insert component 32 are respectively moldingly received into the third through opening 342 and the third latching notches 346 in a snap fit type engagement. Thus, the third insert component 32 is mechanically locked into the third molded component 34, the movement of the third insert component 32 relative to the third molded component 34 can be prevented. No movement of the second insert component 22 relative to second molded component 24 may occur.

It should be understood that if only one third protrusion 322 is formed on the third insert component 32, and only one third latching notch 346 is formed in the third molded component 34, a snap fit type engagement of the third insert component 32 with the third molded component 34 can be also achieved.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An insert molded article, comprising:
an insert component including a main body and at least one protrusion protruding outwardly from the main body, the at least one protrusion having a free end larger than an opposed other end thereof abutting against the main body in sectional area; and
a molded component having a inner wall molded with the insert component, the inner wall having at least one latching notch formed therein;
wherein the at least one protrusion of the insert component is moldingly embedded in the at least one latching notch in a snap fit engagement.

2. The insert molded article as claimed in claim 1, wherein the molded component has a through opening formed therein, the inner wall of the molded component defining the through opening, the main body being received in the through opening.

3. The insert molded article as claimed in claim 1, wherein the insert component further includes an embedded brim protruding outwardly around the main body and the protrusion, the inner wall of the molded component having a latching slot formed therein, the embedded brim being moldingly embedded into the latching slot.

4. The insert molded article as claimed in claim 3, wherein the main body has a first surface and a second surface opposed to the first surface, the protrusion being even with the first surface of the main body, the protrusion and the embedded brim being lower than the second surface of the main body.

5. The insert molded article as claimed in claim 4, wherein the latching slot divides the inner wall of the molded component into an upper wall portion and a lower wall portion, the latching notch being formed in the upper wall portion and communicating with the through opening.

6. The insert molded article as claimed in claim 1, wherein the protrusions is one of a T-shaped arm, a horn-shaped protrusion, or a trapezium-shaped protrusion.

7. An insert molded article, comprising:
an insert component including a main body and a plurality of protrusions protruding outwardly from the first main body, each of the protrusions having a free end larger than an opposed other end thereof abutting against the main body in sectional area; and
a molded component having a wall molded with the insert component, the wall having a plurality of latching notches formed therein;
wherein the protrusion portion of the insert component are respectively moldingly embedded in the latching notches in a snap fit engagement.

8. The insert molded article as claimed in claim 7, wherein the molded component has a through opening formed therein, the inner wall of the molded component defining the through opening, the main body being received in the through opening.

9. The insert molded article as claimed in claim 7, wherein the insert component further includes an embedded brim protruding outwardly around the main body and the protrusions, the inner wall of the molded component having a latching slot formed therein, the embedded brim being moldingly embedded into the latching slot.

10. The insert molded article as claimed in claim 9, wherein the main body has a first surface and a second surface opposed to the first surface, the protrusions being even with the first surface of the main body, the protrusion and the embedded brim being lower than the second surface of the main body.

11. The insert molded article as claimed in claim 10, wherein the latching slot divides the inner wall of the molded component into an upper wall portion and a lower wall portion, the latching notch being formed in the upper wall portion and communicated with the through opening.

12. The insert molded article as claimed in claim 7, wherein each of the protrusions is one of a T-shaped arm, a horn-shaped protrusion, or a trapezium-shaped protrusion.
